(19) United States
(12) Patent Application Publication
(10) Pub. No.: US 2026/0292001 A1
(43) Pub. Date: Sep. 24, 2026

(54) Method And Apparatus For Selective Transmission Of IMS Signaling And Media Data Via Control Plane Or User Plane In A Non-Terrestrial Network

(71) Applicant: MediaTek Inc., Hsinchu City (TW)

(72) Inventors: Yu-Ching Tung, Hsinchu City (TW); Chien-Yi Wang, Hsinchu City (TW); Yuan-Chieh Lin, Hsinchu City (TW)

(73) Assignee: MediaTek Inc., Hsinchu City (TW)

(21) Appl. No.: 19/560,147

(22) Filed: Mar. 9, 2026

Related U.S. Application Data
(60) Provisional application No. 63/775,381, filed on Mar. 21, 2025.

(51) Int. Cl. H04L 65/1016; H04L 65/1104; H04W 76/50

(52) U.S. Cl. CPC H04L 65/1016; H04L 65/1104; H04W 76/50

(57) ABSTRACT

Various solutions for selective transmission of IMS signaling and media data via control plane or user plane in a non-terrestrial network are described. A user equipment (UE) may receive an IP multimedia subsystem (IMS) call request. Then, the UE may initiate an IMS call associated with the IMS call request. The UE may perform at least one of transmitting a session initiation protocol (SIP) message of the IMS call to a network node via a control plane (CP), and transmitting media data of the IMS call via at least one of the CP or a user plane (UP) to the network node based on a radio condition.

### CROSS REFERENCE TO RELATED PATENT APPLICATION(S)

The present disclosure is part of a non-provisional application claiming the priority benefit of U.S. Application No. 63/775,381, filed 21 Mar. 2025, the content of which herein being incorporated by reference in its entirety.

### TECHNICAL FIELD

The present disclosure is generally related to wireless communications and, more particularly, to a method and apparatus for selective transmission of IP Multimedia Subsystem (IMS) signaling and media data via control plane or user plane in a non-terrestrial network.

### BACKGROUND

Unless otherwise indicated herein, approaches described in this section are not prior art to the claims listed below and are not admitted as prior art by inclusion in this section.

In non-terrestrial network (NTN) environments, multimedia communication is often limited by significant bandwidth constraints, which directly lead to longer durations for radio bearer (RB) establishment.

Traditionally, an IMS voice call performed over the user plane (UP) requires a sequential establishment procedure. First, the signaling radio bearer (SRB) must be established to handle control signals. Subsequently, the data radio bearer (DRB) must be established to carry the actual voice or media data. This sequential process introduces an unnecessary waiting time, which is particularly critical for emergency (EMS) calls. In emergency scenarios, every second is vital, yet the latency inherent in NTN links makes the standard DRB setup procedure a major bottleneck.

Furthermore, while the control plane (CP) offers higher priority, lower latency, and higher reliability compared to the user plane, it also involves larger protocol overhead. Conventional systems lack a flexible mechanism to manage the competing technical performance characteristics of these transmission planes. Specifically, these systems lack the capability to bypass the DRB establishment time for media data when radio conditions are poor or when the call priority is exceptionally high.

Therefore, there is a need for a solution that optimizes transmission capacity and reduces setup latency by intelligently selecting between or splitting data across the CP and UP based on call types and real-time radio conditions.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to selective transmission of IMS signaling and media data via control plane or user plane in a non-terrestrial network.

In one aspect, a method may involve an apparatus receiving an IP multimedia subsystem (IMS) call request. The method may also involve the apparatus initiating an IMS call associated with the IMS call request. The method may further involve the apparatus performing at least one of transmitting a session initiation protocol (SIP) message of the IMS call to a network node via a control plane (CP), and transmitting media data of the IMS call via at least one of the CP or a user plane (UP) to the network node based on a radio condition.

In another aspect, a method may involve a network node performing at least one of receiving a session initiation protocol (SIP) message of an IP multimedia subsystem (IMS) call from a user equipment (UE) via a control plane (CP), and receiving media data of the IMS call via at least one of the CP or a user plane (UP) from the UE based on a radio condition.

In another aspect, an apparatus may comprise a transceiver which, during operation, wirelessly communicates with a network node. The apparatus may also comprise a processor communicatively coupled to the transceiver. The processor, during operation, may perform operations comprising receiving an IP multimedia subsystem (IMS) call request. The processor may also perform operations comprising initiating an IMS call associated with the IMS call request. The processor may also perform operations comprising performing at least one of transmitting a session initiation protocol (SIP) message of the IMS call to a network node via a control plane (CP), and transmitting media data of the IMS call via at least one of the CP or a user plane (UP) to the network node based on a radio condition.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1 is a diagram of an example network environment in which various proposed schemes in accordance with implementations of the present disclosure.

FIG. 2 illustrates the protocol stack architecture and the differentiated path allocations between a UE and an NT network node within an NTN in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to selective transmission of IMS signaling and media data via control plane or user plane in a non-terrestrial network. According to the present disclosure, a number of possible solutions may be implemented separately or jointly. That is, although these possible solutions may be described below separately, two or more of these possible solutions may be implemented in one combination or another.

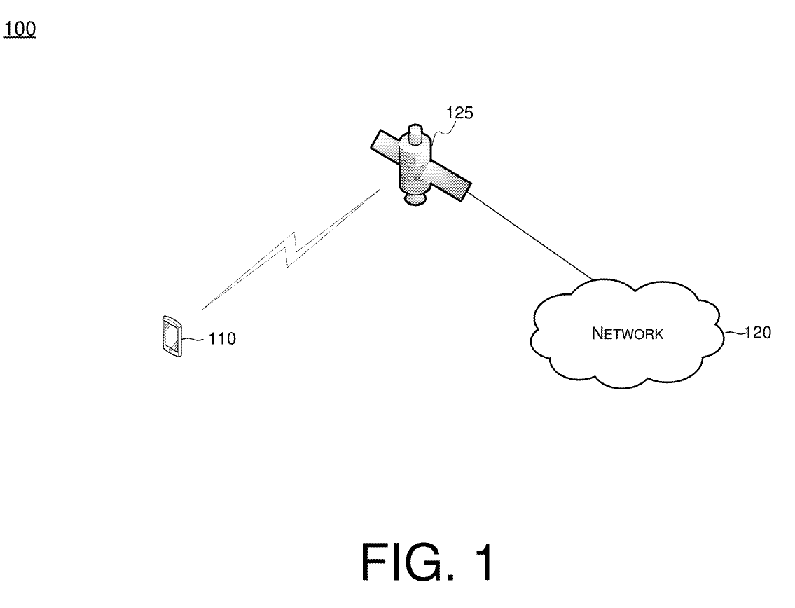

FIG. 1 illustrates an example network environment 100 in which various proposed schemes in accordance with implementations of the present disclosure. The network environment 100 may involve a UE 110 and a wireless network 120 (e.g., an LTE network, a 5G network, a NR network, an IoT network, an NB-IoT network, an IIoT network, an NTN network, a 6G network or any combination thereof). The UE 110 may communicate with the wireless network 120 via a network node 125. In some cases, the network node 125 may be a non-terrestrial (NT) network node (e.g., a satellite) of an NTN. For these cases, the network node 125 may further communicate with a terrestrial network node (e.g., a base station (BS) such as a gNB, eNB or transmission/reception point (TRP)) in the wireless network 120, for relaying the wireless signals received from the UE 110 to the terrestrial network node or relaying the wireless signals received from the terrestrial network node to the UE 110. In some cases, network node 125 may be a terrestrial network node (e.g., a base station (BS) such as a gNB, eNB, or transmission/reception point (TRP)). Each of UE 110 and network node 125 may be configured to perform operations pertaining to the selective transmission of IMS signaling and media data via the control plane or user plane under various proposed schemes in accordance with the present disclosure, as described below.

Under a proposed scheme in accordance with the present disclosure, in the communication architecture for NTNs, the UE 110 enables differentiated path selection between the CP and the UP based on the specific call type and the real-time status of the radio environment. The CP, which encompasses the non-access stratum (NAS) and radio resource control (RRC) layers, is characterized by its ability to provide higher priority, lower latency, and increased reliability compared to the UP. Furthermore, the CP offers enhanced security protection, although it involves a larger protocol overhead relative to the UP. Conversely, the UP utilizes the packet data convergence protocol (PDCP) layer and typically operates in an unacknowledged mode to provide less protocol overhead, which is suitable for high-volume data transmission despite having a lower priority.

The handling of an IMS call request is determined by whether the call is categorized as an EMS call or a normal call. For an EMS call, the signaling information, specifically the session initiation protocol (SIP) message, is always configured to be transmitted via the CP to ensure high priority and to avoid transmission errors or retries. In contrast, a normal call is configured with the flexibility to tolerate the waiting time associated with creating a data radio bearer (DRB) or the potential error handling and retries that may occur when transmitting via the UP.

Regarding the transmission of media data, the UE 110 provides advanced flexibility to optimize capacity and adapt to radio conditions. The media of a call is selectively routed to either the CP or the UP, depending on the current status of the UP. To further optimize transmission capacity, the media data may be split and transferred via both the CP and the UP simultaneously. Additionally, the UE 110 supports independent routing for separate link directions, where the uplink (UL) and downlink (DL) media transfers are conducted via different planes based on the current radio condition.

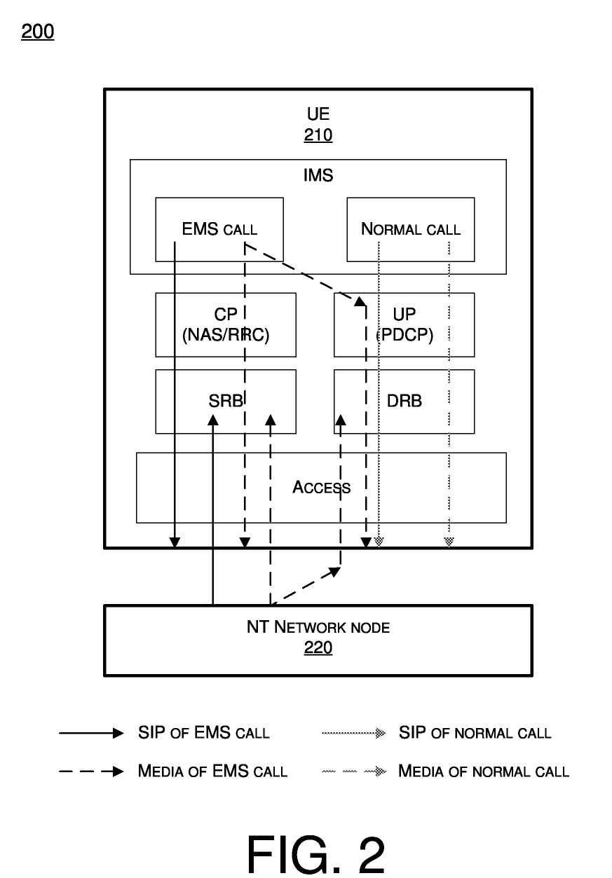

FIG. 2 illustrates the protocol stack architecture 200 and the differentiated path allocations between a UE 210 and a non-terrestrial (NT) network node 220 (such as a satellite or a gateway) within an NTN in accordance with implementations of the present disclosure. FIG. 2 further provides a detailed representation of the interaction between the IMS layer, the CP (NAS/RRC), and the UP (PDCP) across both UL and DL directions.

Specifically, the routing configurations for SIP messages and media data are determined by the call type. For an EMS Call, represented by black arrows, the SIP message is allocated to the CP and the SRB to prioritize reliability and low latency. In contrast, the associated media data for an EMS call exhibits greater flexibility, as the media data may be distributed across both the SRB within the CP and the DRB within the UP, depending on real-time radio conditions.

For a normal call, represented by grey arrows, the communication primarily utilizes the UP and the DRB for data transfer. This reflects the ability of normal calls to utilize an overhead-optimized transmission scheme while tolerating the standard establishment procedures associated with the UP plane. In an event that the call is a normal call, the uplink media data and the downlink media data are capable of being transmitted through different planes based on the radio condition. By utilizing independent routing for separate link directions, the UE 210 ensures that the normal call may maintain connectivity even in an event that the radio condition for a specific direction requires the higher reliability of the CP.

The lower section of FIG. 2 further clarifies the interaction between the UE 210 and the NT network node 220, demonstrating how signaling and media streams are split or independently routed across different planes to optimize transmission capacity and adapt to current prevailing radio conditions.

### Illustrative Implementations

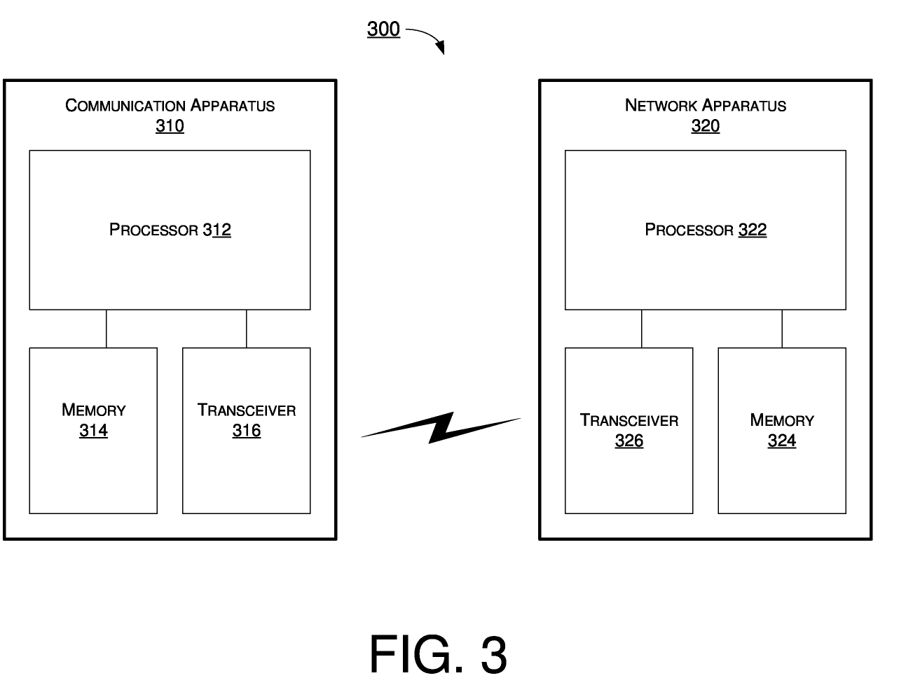

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes, and methods described herein of selective transmission of IMS signaling and media data via CP or UP, including scenarios/schemes described above, as well as processes 400 and 500 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, a digital camera, or a computing equipment such as a tablet computer, a laptop computer, or a notebook computer. Communication apparatus 310 may also be a part of a machine type apparatus, which may be an IoT, NB-IoT, or IIoT apparatus, such as an immobile or a stationary apparatus, a home apparatus, a wire communication apparatus, or a computing apparatus. For instance, communication apparatus 310 may be implemented in a smart thermostat, a smart fridge, a smart door lock, a wireless speaker, or a home control center. Alternatively, communication apparatus 310 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3, such as a processor 312, for example. Communication apparatus 310 may further include one or more other components not pertinent to the proposed scheme of the present disclosure (e.g., internal power supply, display device, and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router, or a gateway. For instance, network apparatus 320 may be implemented in an eNB in an LTE network, in a gNB in a 5G/NR, IoT, NB-IoT or IIoT network, or in a satellite or base station in a 6G network. Network apparatus 320 may include at least some of those components shown in FIG. 3, such as a processor 322, for example. Processor 322 may further include protocol stacks and a set of control functional modules and circuits. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged, and configured to perform specific tasks in a device (e.g., as represented by communication apparatus 310) and a network (e.g., as represented by network apparatus 320) in accordance with various implementations of the present disclosure.

In some implementations, communication apparatus 310 may also include a memory 314 coupled to processor 312 and capable of being accessed by processor 312 and storing data therein. In some implementations, communication apparatus 310 may further include a transceiver 316 coupled to processor 312 and capable of wirelessly transmitting and receiving data. In some implementations, transceiver 316 may be capable of wirelessly communicating with different types of UEs and/or wireless networks of different RATs, e.g., 2G GSM, 3G UMTS, 4G LTE, 5G NR, and/or 6G.

In some implementations, network apparatus 320 may further include a memory 324 coupled to processor 322 and capable of being accessed by processor 322 and storing data therein, and a transceiver 326 coupled to processor 322 and capable of wirelessly transmitting and receiving data. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 and network apparatus 320 are provided below with process 400 and process 500. In which, communication apparatus 310 is implemented in or as a communication apparatus or a UE, and network apparatus 320 is implemented in or as a network node of a communication network (e.g., a satellite or a BS).

### Illustrative Processes

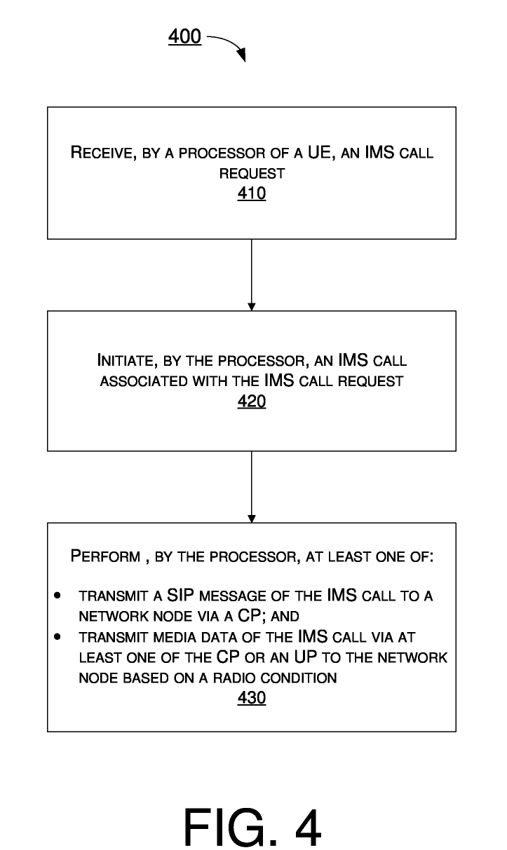

FIG. 4 illustrates an example process 400 in accordance with an implementation of the present disclosure. Process 400 may be an example implementation of the above scenarios/schemes, whether partially or completely, with respect to the selective transmission of IMS signaling and media data via CP or UP. Process 400 may represent an aspect of the implementation of features of communication apparatus 310. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE (e.g., UE 110) or machine-type devices. Solely for illustrative purposes and without limitation, process 400 is described below in the context of communication apparatus 310 as a UE. Process 400 may begin at block 410.

At block 410, process 400 may involve processor 312 of communication apparatus 310 receiving an IMS call request. Process 400 may proceed from block 410 to block 420.

At block 420, process 400 may involve processor 312 initiating an IMS call associated with the IMS call request. Process 400 may proceed from block 420 to block 430.

At block 430, process 400 may involve processor 312 performing at least one of: transmitting a SIP message of the IMS call to a network node (e.g., network apparatus 320) via a CP, and transmitting media data of the IMS call via at least one of the CP or an UP to the network node based on a radio condition.

In some implementations, the IMS call is an emergency (EMS) call.

In some implementations, the IMS call is a normal call.

In some implementations, the SIP message of the IMS call is transmitted via an SRB of the CP without establishing a DRB.

In some implementations, process 400 may involve processor 312 determining a quality of the UP. Process 400 may involve processor 312 transmitting, via transceiver 316, the media data via the UP in an event that the quality of the UP is greater than a predefined threshold.

In some implementations, process 400 may involve processor 312 transmitting, via transceiver 316, a portion of the media data via the CP without establishing the DRB. Process 400 may involve processor 312 transmitting, via transceiver 316, another portion of the media data via the UP by establishing the DRB.

In some implementations, process 400 may involve processor 312 determining a quality of the UP. Process 400 may involve processor 312 transmitting, via transceiver 316, the media data via the CP in an event that the quality of the UP is less than or equal to a predefined threshold.

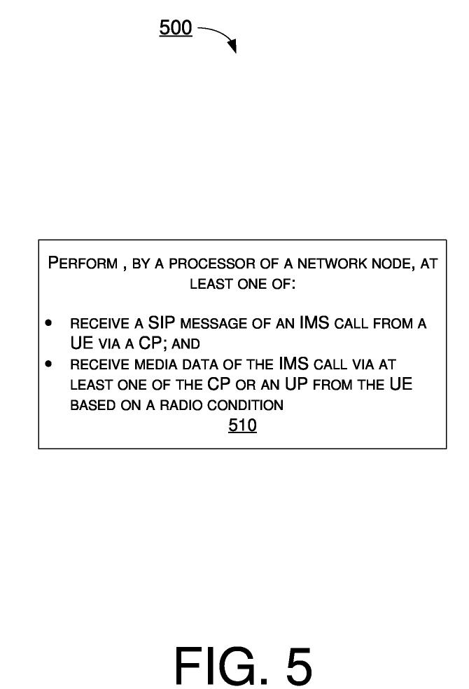

FIG. 5 illustrates an example process 500 in accordance with an implementation of the present disclosure. Process 500 may be an example implementation of the above scenarios/schemes, whether partially or completely, with respect to the selective transmission of IMS signaling and media data via CP or UP. Process 500 may represent an aspect of the implementation of features of network apparatus 320. Process 500 may include one or more operations, actions, or functions as illustrated by one or more of block 510. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any network entity in the 4G, 5G, or 6G network, including an NT network node or a base station. Solely for illustrative purposes and without limitation, process 500 is described below in the context of network apparatus 320. Process 500 may begin at block 510.

At block 510, process 500 may involve processor 322 of network apparatus 320 performing, by a processor of a network node, at least one of: receiving a SIP message of an IMS call from a UE (e.g., communication apparatus 310) via a CP, and receiving media data of the IMS call via at least one of the CP or an UP from the UE based on a radio condition.

In some implementations, the IMS call is an emergency (EMS) call.

In some implementations, the IMS call is a normal call.

In some implementations, the SIP message of the IMS call is received via an SRB of the CP without establishing a DRB.

In some implementations, process 500 may involve processor 322 receiving, via transceiver 326, the media data via the UP in an event that a quality of the UP is greater than a predefined threshold.

In some implementations, process 500 may involve processor 322 receiving, via transceiver 326, a portion of the media data via the CP without establishing the DRB. Process 500 may involve processor 322 receiving, via transceiver 326, another portion of the media data via the UP by establishing the DRB.

In some implementations, process 500 may involve processor 322 receiving, via transceiver 326, the media data via the CP in an event that a quality of the UP is less than or equal to a predefined threshold.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), an IP multimedia subsystem (IMS) call request;
initiating, by the processor, an IMS call associated with the IMS call request; and
performing, by the processor, at least one of:
transmitting a session initiation protocol (SIP) message of the IMS call to a network node via a control plane (CP); and
transmitting media data of the IMS call via at least one of the CP or a user plane (UP) to the network node based on a radio condition.

2. The method of claim 1, wherein the IMS call is an emergency (EMS) call.

3. The method of claim 1, wherein the IMS call is a normal call.

4. The method of claim 1, wherein the SIP message of the IMS call is transmitted via a signaling radio bearer (SRB) of the CP without establishing a data radio bearer (DRB).

5. The method of claim 1, wherein the transmitting of the media data of the IMS call via at least one of the CP or the UP to the network node based on the radio condition further comprises:
determining a quality of the UP; and
transmitting the media data via the UP in an event that the quality of the UP is greater than a predefined threshold.

6. The method of claim 1, wherein the transmitting of the media data of the IMS call via at least one of the CP or the UP to the network node based on the radio condition further comprises:
transmitting a portion of the media data via the CP without establishing the DRB; and
transmitting another portion of the media data via the UP by establishing the DRB.

7. The method of claim 1, wherein the transmitting of the media data of the IMS call via at least one of the CP or the UP to the network node based on the radio condition further comprises:
determining a quality of the UP; and
transmitting the media data via the CP in an event that the quality of the UP is less than or equal to a predefined threshold.

8. A method, comprising:
performing, by a processor of a network node, at least one of:
receiving a session initiation protocol (SIP) message of an IP multimedia subsystem (IMS) call from a user equipment (UE) via a control plane (CP); and
receiving media data of the IMS call via at least one of the CP or a user plane (UP) from the UE based on a radio condition.

9. The method of claim 8, wherein the IMS call is an emergency (EMS) call.

10. The method of claim 8, wherein the IMS call is a normal call.

11. The method of claim 8, wherein the SIP message of the IMS call is received via a signaling radio bearer (SRB) of the CP without establishing a data radio bearer (DRB).

12. The method of claim 8, wherein the receiving of the media data of the IMS call via at least one of the CP or the UP from the UE based on the radio condition further comprises:
receiving the media data via the UP in an event that a quality of the UP is greater than a predefined threshold.

13. The method of claim 8, wherein the receiving of the media data of the IMS call via at least one of the CP or the UP from the UE based on the radio condition further comprises:
receiving a portion of the media data via the CP without establishing the DRB; and
receiving another portion of the media data via the UP by establishing the DRB.

14. The method of claim 8, wherein the receiving of the media data of the IMS call via at least one of the CP or the UP from the UE based on the radio condition further comprises:
receiving the media data via the CP in an event that a quality of the UP is less than or equal to a predefined threshold.

15. An apparatus, comprising:
a transceiver which, during operation, communicates wirelessly; and
a processor communicatively coupled to the transceiver such that, during operation, the processor performs operations comprising:
receiving an IP multimedia subsystem (IMS) call request;
initiating an IMS call associated with the IMS call request; and
performing at least one of:
transmitting, via the transceiver, a session initiation protocol (SIP) message of the IMS call to a network node via a control plane (CP); and
transmitting, via the transceiver, media data of the IMS call via at least one of the CP or a user plane (UP) to the network node based on a radio condition.

16. The apparatus of claim 15, wherein the IMS call is an emergency (EMS) call.

17. The apparatus of claim 15, wherein the IMS call is a normal call.

18. The apparatus of claim 15, wherein the SIP message of the IMS call is transmitted via a signaling radio bearer (SRB) of the CP without establishing a data radio bearer (DRB).

19. The apparatus of claim 15, wherein, in transmitting the media data of the IMS call via at least one of the CP or the UP to the network node based on the radio condition, the processor is further configured to perform operations comprising:
determining a quality of the UP; and
transmitting the media data via the UP in an event that the quality of the UP is greater than a predefined threshold.

20. The apparatus of claim 15, wherein, in transmitting the media data of the IMS call via at least one of the CP or the UP to the network node based on the radio condition, the processor is further configured to perform operations comprising:
transmitting a portion of the media data via the CP without establishing the DRB; and
transmitting another portion of the media data via the UP by establishing the DRB.
